(19) United States
(12) Patent Application Publication
(10) Pub. No.: US 2005/0250580 A1
(43) Pub. Date: Nov. 10, 2005

(54) Method and system for playing games using wireless communication

(76) Inventor: John Bird, Lakeville, MN (US)

Correspondence Address: Gary L. Huusko;Suite 600, 7300 West 147th Street, Apple Valley, MN, 55124, US

(21) Appl. No.: 10/838,463

(22) Filed: May 4, 2004

(51) Int. Cl. G06F 19/00; G06F 17/00

(52) U.S. Cl. 463/42

(57) ABSTRACT

A game method and system is shown, comprising at least one cell phone and a web site wherein a game sponsor sets rules of the game and provides the rules to users of the cell phones, the game sponsor then provides clues to the game, the user solves the clues and provides solutions to the sponsor and the sponsor determines a winner of the game based upon the solutions provided. The games can be of any variety, such as the games of tag, elimination and treasure hunt. The preferred embodiment shows the cell phone having text messaging capabilities. Other embodiments would show the cell phone having picture taking, image capture or video capture capabilities as well. The web site comprises the usual and customary capabilities of web sites in general, such as having the ability to allow password entrance, to accept uploaded information, to download and disseminate information to individual cell phones and enmasse to a plurality of cell phones by way of text messaging, and to accept secure forms of fee payments, such as accepting credit cards or other Internet based payment means.

### FIELD OF INVENTION

The present invention relates generally to the field of games, and more particularly utilizing wireless communications, such as cell phones and related technology, in a variety of games, such as a hunt game, tag, and elimination.

### BACKGROUND OF INVENTION

Games as a form of recreation or in conjunction with commercial marketing are extremely popular and varied in modern society. The form of games varies widely, from games participated in a backyard by children, to board games, to the widely popular interactive electronic and/or computer games. There are also games that utilize pagers, global positioning systems, and newspapers, as sources of acquiring and disseminating information relevant to the game.

In particular, there are games, such as hide-and-seek, elimination (sometimes referred to as “war”), tag, and treasure hunts that have been played by children in backyards for years, and yet remain widely popular.

In U.S. Pat. No. 5,236,200 to McGregor, a card-like structure enables the playing of a treasure hunt game wherein various clues are preprinted on detachable elements formed integrally with a greeting card. There are also known to be treasure hunt type games utilizing newspapers or other print media, whereby clues are periodically published, such as daily, and participants read and compute the clues and attempt to find the hidden treasure using as few clues as necessary. Treasure hunts of this nature are often linked to a community celebratory event.

In U.S. Pat. No. 6,530,841 to Bull, an electronic tag game is disclosed wherein the participants utilize wireless location devices, capable of keeping track of the person sought to be tagged, and the person who is seeking to tag. A variation of the game of tag played with laser beam activated sensors is disclosed in U.S. Pat. Appl. Ser. No. 10/075,215, Pub. No. 2002/0111201, wherein each participant uses a location-based software program that is coupled to a wide area computer network, which in turn controls the game and monitors the location and action of the participants, to ascertain the location of other participants and “shoot” them with the laser beam device, thus activating the laser beam sensor. Points are thus scored for “hits” to other participants, or subtracted for receiving “hits” from other participants.

What is lacking in all of the above variations of games is a simple, user friendly, method and system of playing games that will attract participants and be useful for marketing opportunities, utilizing cell phones and cell phone technology, including text messaging, Internet accessibility, and Voice Response systems.

### SUMMARY OF INVENTION

It is an object of the present invention to meet the above identified needs and others. Particularly, it is an object of the present invention to provide a gaming method and system which by using one's cell phone users can engage in recreational gaming, specifically a treasure hunt or the games of tag and elimination.

Additional objects, advantages and novel features of the invention will be set forth in the description which follows or may be learned by those skilled in the art through reading these materials or practicing the invention. The objects and advantages of the invention may be achieved through the means recited in the attached claims. To achieve the stated and other objects of the present invention, as embodied and described below, the invention may comprise:

A method of playing a game using cell phones comprising the steps of: providing a web site and a cell phone system; transmitting between the web site, voice response and the cell phone system text messages about the game to a plurality of cell phones which are being used by game participants; and receiving with the cell phone system messages from the computer gaming host about the game, wherein the received messages are in response to the transmitted messages.

One embodiment of the game is a treasure hunt. There currently exist city events that are built around clues. Currently the clues are posted either on a sheet of paper located within a sponsoring business or in a newspaper. In the present invention, there would be an opportunity to have a “subscription” that would allow a participant to receive those clues through text messaging instead. A participant would go to a web site, utilizing either their computer or the web accessibility function of a computer device and register to participate in the game. The organizer of the treasure hunt would thus be able to send that text message clue to anyone who has registered so that the particular participant receives it wherever they may be at the time it is published.

A game administrator would agree to sign up to distribute the organizer's or sponsor's clues through this network. The administrator would post information on the web site indicating the game and parameters for people to join. The administrator would set up the times that the clues would be distributed to the subscribers and would also enter all of the clues.

Individuals wishing to subscribe to receive these clues would sign in through the web site and could utilize a credit card or other funds transfer capability to pay a joining fee. The individual would then enter their name and contact number that would be used to transmit the message containing the clue. The clue could include text, picture, voice or video, depending upon the desires of the administrator and functional capabilities of the participant's cell phone.

When the time comes for the clue to be distributed, the system will transmit the clue using the messaging system to all subscribers.

A variation to this would be that a sponsor may build clues based on the finding of a previous clue and when a player would find and transmit the code for a clue through either voice response or voice recognition, the following clue would then be transmitted back to them. Other variations would include directing the participant, through the clues or sets of clues, to a sponsoring business for a code word or subsequent clue.

The game method and system would also lend itself quite readily to the game of elimination. In this embodiment, there would be a sponsor for the game that would sign up for the game and give it a name, key phrase, parameters to play the game such as what type of transmission will be used (text, picture, video, or voice), dates, times, how to complete the elimination, which way a witness can identify an elimination, where it would be played, what are the winning distributions and who can qualify to play.

Each interested player would sign up for a game that would have the objective to eliminate everyone else from that game. The player would sign up on the web site with their name, contact number and credit card payment or funds transfer information for the subscription to each game. At this point they would be sent a key phrase that will be used for the game.

Every participant receives a name or names of some one or a group of persons playing in that game. Each participant would then try to eliminate that person or persons by contacting them in the manner specified by the sponsor and saying the phrase designated by the sponsor. If another game player does not witness the elimination event, then it will be deemed a successful elimination and the participant would then receive the next assignment. If another player witnesses the elimination event, the elimination is foiled and the participant who attempted the elimination would then be out of the game. The player witnessing the elimination event would report to the sponsor: the time of the elimination; the place the elimination occurred; and the phrase used in the elimination. The players that are affected by the elimination of “target” players would receive new assignments as needed. This would continue until all players except one is left in the game.

The process for the elimination would be chosen by the sponsor for all players to follow. The sponsor could choose to require a photo elimination wherein the player must take or obtain a photo of the individual and submit that to the system which would then transmit that to the “victim” and request confirmation. The key phrase would also need to be used to communicate the correct game that has been invoked. The sponsor may choose instead to have an identifier used, such as a process, code or a physical item, that would be given to the “victim” and the “victim” would then be required to phone in the code or identification of the eliminating player thus verifying the elimination. The eliminator would also call and confirm the elimination utilizing voice responses prompting for key information.

Any discrepancy in the contact would require the sponsor to arbitrate the disagreement. There would be a timeframe that either party or the witness must contact the system to identify the action without either forfeiting the game or not being allowed to witness an elimination.

This variation could be done through web interaction, text messaging devices, video and picture devices and voice response technology.

A further embodiment is the game of tag. Similar to that described above, but unlike the elimination embodiment, there would be no “out”, just a tally of the number of tags a player accomplished and possibly comparing that to the number of times a player was tagged. The winner would be notified within a specific timeframe. Each time a tag is communicated, the next assignment, or player to be tagged, would be transmitted to the tagging player.

The sponsor may either choose to allow for witnessing the tag as in elimination or not. A variation to this would be to also allow players to tag more than one person at a time. The players would receive a list of other players and the system would keep a tally of all the ones the player has “tagged.” When one player completes tags on everyone else on his or her list, the game would end.

Advantages include a variety of uses of any of the games, such as for business functions (i.e. team building, outings); for College campus fun activities; for Civic events; by camps and amusement locations; for fundraising; by entertainment entities (i.e. hotels, groups, ships, resorts); for community development; by church groups and youth organizations; by fraternities and sororities; by community groups for meetings and introductions; and by individuals for general entertainment.

### DESCRIPTION OF THE DRAWINGS

FIG. 1 is a schematic drawing of the preferred embodiment.

FIG. 2 is a schematic drawing of the treasure hunt game embodiment.

FIG. 3 is a schematic drawing of the elimination game embodiment.

FIG. 4 is a schematic drawing of the tag game embodiment.

### DETAILED DESCRIPTION OF THE DRAWINGS

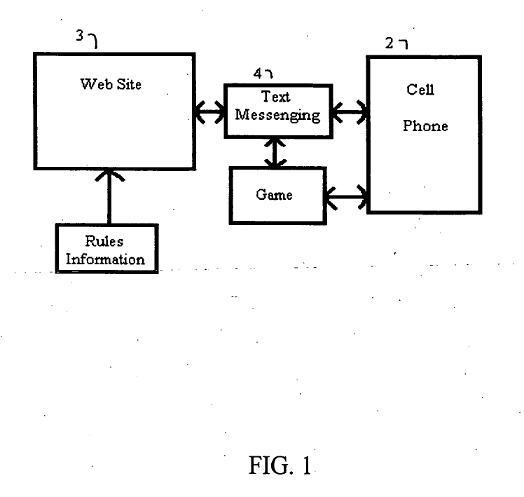

Referring to FIG. 1, a game I is shown, comprising at least one cell phone 2 and a web site 3. The preferred embodiment shows the cell phone 2 having text messaging 4 capabilities. Other embodiments would show the cell phone 2 having picture taking, image capture or video capture capabilities as well. The web site 3 comprises the usual and customary capabilities of web sites in general, such as having the ability to allow password entrance, to accept uploaded information, to download and disseminate information to individual cell phones and enmasse to a plurality of cell phones by way of text messaging, and to accept secure forms of fee payments, such as accepting credit cards or other Internet based payment means.

A game sponsor would name the game and set the rules and parameters of the game. Advertising through use of the Internet, newspapers or other printed media would alert potential players of the game and direct them to the web site. The rules would be posted on the web site, as well as instructions on how to register or sign up for the game. Registration would comprise setting up a user name and password, as well as inputting credit card information, if the game is fee based. Once the player completes the registration process, he or she is given access to the game rules and parameters of the game. Depending upon the game played, the player is either given instructions on how to proceed, or given clues to solve or find. The player who meets the objectives of the game the fastest, or scores the highest number of points, would win the game.

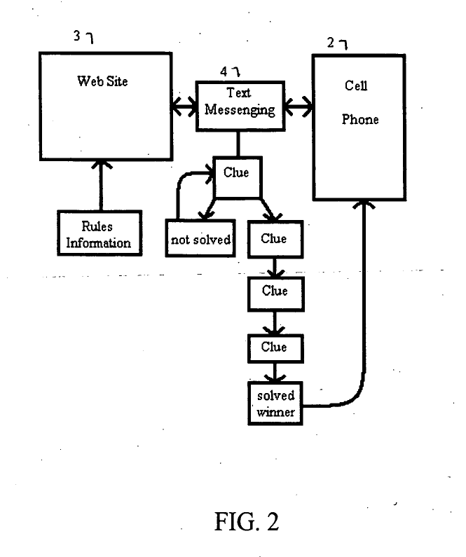

Referring now to FIG. 2, a treasure hunt game is disclosed, comprising at least one cell phone 2 and a web site 3. A potential player registers as described above, and upon successfully registering, receives the first in a series of clues by either viewing the clue on the web site, or receiving the clue via his or her cell phone by use of text messaging. The player then either solves the clue or finds the location that is referenced by the clue, and transmits that solution or location to the web site. The transmission can be either by text messaging to the web sites telephone access point, or by accessing the web site via the Internet accessibility function of the cell phone and uploading the information, or by accessing the web site via a computer and uploading the solution or location. Once the player has successfully finished the first clue level, he or she will be able to participate in the next level.

Another embodiment shows the player receiving the clue, going to a location referenced by the clue or its solution, and obtaining a further clue or the password to continue participating in the game. The password would be transmitted to the web site, which would then allow the player to receive the subsequent clue either at that time or at the time the sponsor decides to disseminate the subsequent clue.

Still another embodiment shows the clues to be disseminated in a periodic succession, with no specific solution being available, yet describing a location. The player who determines the location first wins, either by going to the location and finding the treasure or prize, or by uploading to the web site the location in any of the manners previously mentioned. The first player to provide the correct location is declared the winner, and would receive the prize.

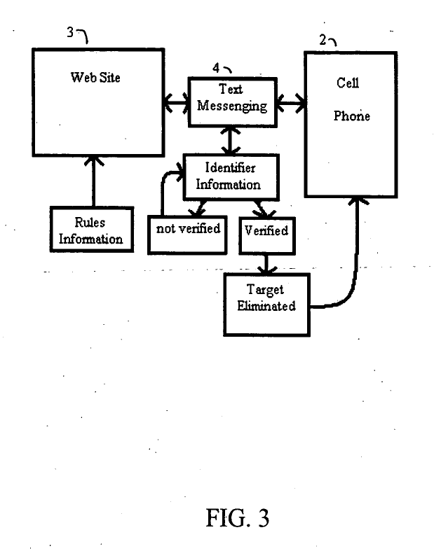

Referring now to FIG. 3, the game of elimination is shown, comprising at least one cell phone 2 and a web site 3. In this embodiment, the registration process would include the player providing additional identifier information that the sponsor would disseminate to other players for use in finding and eliminating the player providing such information. The additional identifier information would include such items as name, clothing, height, weight, hairstyle and/or color, eye color, or other particular characteristics. The additional identifier information would be required to be updated on a daily basis, or more or less frequently, if any of the provided identifier information changed, such as changing clothes or hairstyle or color. The sponsor would determine and post the rules of engagement and how the player could successfully “eliminate” the “victim.” Elimination could occur through such means as uploading to the web site accurate descriptive information about the targeted victim, including dress, location, time, and any other information that would be useful in identifying the target and proving the target was in the location at the time the player observed the target.

The player, after successfully registering, would receive identifier information about the first target “victim”. The player would thus use the identifier information to locate and identify the target. Once located and identified, the player would upload to the web site the identifier information of the target, and such other information as would be required by the sponsor, the sponsor would then verify the uploaded information, either through comparison to the additional identifier information provided by the target, or by text message to the target with specific information uploaded by the player. Upon verification by the target, or by the comparison of information, the target would then be eliminated, and the player would receive points and information relative to another target. Upon elimination, the eliminated player would be out of the game until a new game began. The last player who has not been eliminated, would be deemed the winner.

Another embodiment of the elimination game would require the player seeking the target to do so secretly and without detection. If the target, or another player, observed the player seeking to eliminate the target during the act of the elimination, then that eliminating player would be eliminated, thus ending his or her participation in the game.

A further embodiment of the elimination game would allow groups of players to form teams.

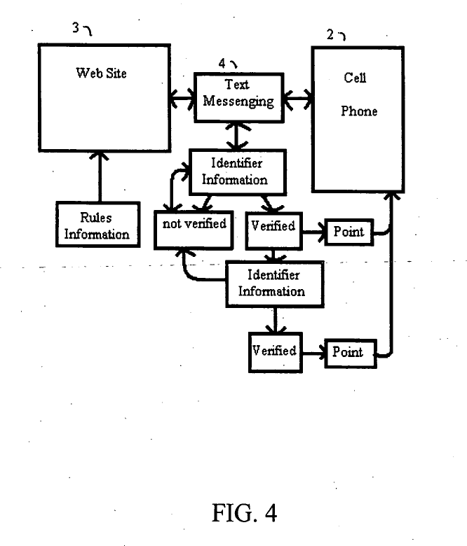

Referring now to FIG. 4, the game of tag is shown, comprising at least one cell phone 2 and a web site 3. The tag game embodiment would be played much in the same way the elimination game embodiment is played, except there would be no “out” for the player tagged. Rather, a scoring system would be incorporated to keep track of the number of “tags” a player made against opposing players and the number of times the player was tagged by another player. A point would be added to a player's score when he or she successfully tagged another player, and a point would be deducted whenever the player was tagged by another player. The game would be ongoing for a specific period of time, and at the end of that time period, the player with the highest score would be declared a winner.

Another embodiment of the tag game would limit the geographical location of the players, or would enlarge the geographical location. Thus, the game could be played within a neighborhood, within a city, or even throughout the country and beyond.

1. A method for playing games using wireless communication comprising:
a wireless communications network capable of transmitting and receiving information;
at least one wireless device capable of transmitting and receiving information;
at least one user of said wireless device;
an Internet web site capable of transmitting and receiving information from said wireless device through said wireless communications network, and;
a game sponsor, whereby said game sponsor sets rules of a game and provides said rules to said user of said wireless device, said game sponsor then provides clues to said game, said user solves said clues and provides solutions to said sponsor and said sponsor determines a winner of said game based upon said solutions provided.

2. The method of claim 1 wherein said wireless device is a cell phone.

3. The method of claim 1 wherein there are a plurality of wireless devices and a plurality of users.

4. The method of claim 1 wherein said wireless device has text messaging capabilities.

5. The method of claim 1 wherein said wireless device has picture, voice, and video transmission and reception capabilities.

6. The method of claim 1 wherein said wireless device has Internet access capabilities.

7. The method of claim 1 wherein said wireless communications network, said wireless device and said web site have Voice Response and Recognition systems capabilities.

8. The method of claim 1 wherein said information comprises games rules, game clues, responses to game clues, solutions, winner determination, pictures, video, text messaging and voice responses.

9. The method of claim 1 wherein said sponsor provides said rules, said clues and said winner determination by posting said rules, said clues and said winner determination on said web site and said user accesses said web site and views said rules, said clues and said winner determination and downloads to said web site said solutions and responses to game clues.

10. The method of claim 1 wherein said sponsor provides said rules, said clues and said winner determination by text messaging and by transmitting pictures, video, and voice responses to said wireless device and wherein said user provides to said sponsor said responses and solutions to said clues by text messaging and by transmitting pictures, video, and voice responses with said wireless device.

11. The method of claim 1 wherein said rules comprise a requirement of a payment of a joining fee subscription by said user to said game.

12. The method of claim 3 wherein said wireless devices have text messaging and picture, voice, and video transmission and reception capabilities, wherein said wireless devices have Internet access capabilities, wherein said wireless communications network, said wireless devices and said web site have Voice Response and Recognition systems capabilities, wherein said information comprises game rules, game clues, responses and solutions to game clues, winner determination, pictures, video, text messaging and voice responses, wherein said sponsor provides said information to said users by posting said information on said web site and said users access said web site and view said information, wherein said sponsor further provides said information to said users by text messaging and transmitting pictures, video, and voice responses to said wireless devices, and wherein said users provide said responses and solutions to said sponsor by posting said solutions to said web site, by text messaging and by transmitting pictures, video, and voice responses with said wireless device.

13. The method of claim 12 wherein said game is the game of treasure hunt.

14. The method of claim 13 wherein said game comprises a plurality of levels, each said level comprising its own set of said clues and said solutions.

15. The method of claim 14 wherein said clues comprise physical location information and said solutions comprise a determination of said physical location.

16. The method of claim 15 wherein said user can continue to play said game and advance to a subsequent level only upon providing said solutions to said clues at each said level.

17. The method of claim 16 wherein said user can continue to play said game and advance to a subsequent level only upon going to said physical location referenced in said clues, conveying to said sponsor said identifying information about said physical location, wherein said sponsor then transmits a subsequent level clue to said user, said user solves said subsequent level clue and provides to said sponsor said solution to said subsequent level clue.

18. The method of claim 17 wherein the winner is said user who determines said physical location first by going to said physical location and finding a treasure.

19. The method of claim 17 wherein the winner is said user who determines said physical location and uploading to said web site said physical location solution.

20. The method of claim 16 wherein said user can continue to play said game and advance to a subsequent level only upon going to said physical location referenced in said clues and obtaining at said physical location a subsequent level clue.

21. The method of claim 12 wherein said game is the game of elimination.

22. The method of claim 21 wherein at least one said user is a targeted victim.

23. The method of claim 22 further comprising said sponsor requiring additional identifier information and game parameters, wherein said additional identifier information comprises said user's name, clothing, height, weight, hairstyle, color of hair, eye color, and other physical characteristics, said user's geographical location and time of day at said location, said additional identifier information being required to be updated periodically as well as when said additional identifier information changes and wherein said game parameters comprise dates and times of said game, rules for completing said elimination, a geographical area of said game, and qualifications of said users.

24. The method of claim 23 wherein said rules for completing said elimination comprise said user providing to said sponsor additional identifier information about said targeted victim, said user contacting said targeted victim and providing to said victim a phrase, said phrase being comprised of a code word or a series of code words provided to said user by said sponsor, and said user completing said elimination without being observed by any other user.

25. The method of claim 24 wherein the rules for completing said elimination further comprise said user giving to said target victim an identifier, wherein said target victim would then contact said sponsor and provide said identifier to said sponsor.

26. The method of claim 25 wherein said identifier comprises a process, a code, or a physical item.

27. The method of claim 26 wherein the means for providing said additional identifier information to said sponsor comprises submission of a photograph of said target victim

28. The method of claim 27 wherein the winner is said user who has not been identified as an observed targeted victim.

29. The method of claim 12 wherein said game is the game of tag.

30. The method of claim 29 wherein each said user is given a list of all such users participating in said game.

31. The method of claim 30 wherein a scoring system would be used by said sponsor, said scoring system comprising said user conveying to said sponsor a positive number of tags said user made against other users and a negative number of times said user was tagged by another user, whereby points would be added to said user's score when said user successfully tagged another user, and points would be deducted whenever said user was tagged by another user, said game would be ongoing for a specific period of time, and the user with the highest score at the end of said specific period of time would be declared winner.

32. The method of claim 31 wherein said rules would limit said users to a geographical location, said geographical location being defined by said sponsor.

33. A system for playing games using wireless communication comprising:
a wireless communications network capable of transmitting and receiving information;
at least one wireless device capable of transmitting and receiving information;
at least one user of said wireless device;
an Internet web site capable of transmitting and receiving information from said wireless device through said wireless communications network, and;
a game sponsor, whereby said game sponsor sets rules of a game and provides said rules to said user of said wireless device, said game sponsor then provides clues to said game, said user solves said clues and provides solutions to said sponsor and said sponsor determines a winner of said game based upon said solutions provided.

34. The system of claim 33 wherein there are a plurality of wireless devices and a plurality of users.

35. The system of claim 33 wherein said wireless device is a cell phone.

36. The system of claim 33 wherein said wireless device has text messaging capabilities.

37. The system of claim 33 wherein said wireless device has picture, voice, and video transmission and reception capabilities.

38. The system of claim 33 wherein said wireless device has Internet access capabilities.

39. The system of claim 33 wherein said wireless communications network, said wireless device and said web site have Voice Response and Recognition systems capabilities.

40. The system of claim 33 wherein said information comprises game rules, game clues, responses to game clues, solutions, winner determination, pictures, video, text messaging and voice responses.

41. The system of claim 33 wherein said rules comprise a requirement of a payment of a joining fee subscription by said user to said game.

42. The system of claim 33 wherein said sponsor provides said rules, said clues and said winner determination by posting said rules, said clues and said winner determination on said web site and said user accesses said web site and views said rules, said clues and said winner determination and downloads to said web site said solutions and responses to game clues.

43. The system of claim 33 wherein said sponsor provides said rules, said clues and said winner determination by text messaging and by transmitting pictures, video, and voice responses to said wireless device and wherein said user provides to said sponsor said responses and solutions to said clues by text messaging and by transmitting pictures, video, and voice responses with said wireless device.

44. The system of claim 35 wherein said wireless devices have text messaging and picture, voice, and video transmission and reception capabilities, wherein said wireless devices haves Internet access capabilities, wherein said wireless communications network, said wireless devices and said web site have Voice Response and Recognition systems capabilities, wherein said information comprises game rules, game clues, responses and solutions to game clues, winner determination, pictures, video, text messaging and voice responses, wherein said sponsor provides said information to said users by posting said information on said web site and said users access said web site and view said information, wherein said sponsor further provides said information to said users by text messaging and transmitting pictures, video, and voice responses to said wireless devices, and wherein said users provide said responses and solutions to said sponsor by posting said solutions to said web site, by text messaging and by transmitting pictures, video, and voice responses with said wireless device.

45. The system of claim 44 wherein said game is selected from the group consisting of elimination, treasure hunt and tag.
